(19) United States
(12) Patent Application Publication
(10) Pub. No.: US 2009/0101164 A1
(43) Pub. Date: Apr. 23, 2009

(54) MINT AND FLOSS ORAL-PRODUCT CONTAINER

(76) Inventors: Robert Isaac Berg, Blaine, WA (US); Tom Hoeltcen, Langley (CA)

Correspondence Address: IPD;c/o Watchstone P+D, plc, 1250 CONNECTICUT AVENUE, N.W., SUITE 700, WASHINGTON, DC, 20036-2657, US

(21) Appl. No.: 12/175,677

(22) Filed: Jul. 18, 2008

Related U.S. Application Data
(60) Provisional application No. 60/950,495, filed on Jul. 18, 2007.
(60) Provisional application No. 60/950,497, filed on Jul. 18, 2007.

(51) Int. Cl. A61C 15/04

(52) U.S. Cl. 132/325

(57) ABSTRACT

An oral-product container is disclosed that includes a plurality of breath fresheners contained therein for breath freshening purposes. The container includes an elongated dental instrument (e.g., a toothpick or dental floss) for hygiene improving purposes contained within the container. In the preferred embodiments, the container has a dispensing opening for dispensing breath fresheners. The container preferably has a laterally movable cover mounted to move between a closed state in which the cover covers both the dispensing opening and the elongated dental instrument and an open state in which the cover exposes both the dispensing opening and the elongated dental instrument.

The present application is a non-provisional to U.S. Provisional Application Nos. 60/950,495 and 60/950,497 both filed on Jul. 18, 2007, the entire disclosures of which are incorporated herein by reference as though recited herein in full.

### BACKGROUND

1. Field of the Invention

The present invention relates to containers for oral-products and some preferred embodiments relate to containers for breath fresheners, such as, e.g., mints or the like.

The preferred embodiments of the present invention relates to improvements in oral product containers, said containers including, in some embodiments, features similar to features in, e.g., the following U.S. Patents and Applications, the entire disclosures of which are incorporated herein by reference (along with improvements shown and described below):

1. U.S. Provisional Application No. 60/511,298;

2. U.S. Pat. No. 7,237,677;

3. U.S. application Ser. No. 10/595,421;

4. U.S. application Ser. No. 29/218,381;

5. U.S. Pat. No. D547,175;

6. U.S. Application Ser. No. 60/825,120;

7. U.S. application Ser. No. 11/758,489.

2. Discussion of the Background

In some circumstances in modern culture, individuals seek to enhance their personal image, such as, e.g., the appearance of their teeth, their odor, and/or the like. Individuals may seek to enhance their personal image for a variety of reasons, such as, by way of example, to: a) prepare for a date and/or a romantic encounter; b) make a good impression on one or more individual; c) enhance one's self-confidence; and/or d) achieve a wide variety of other goals.

Breath Freshening

In modern culture, the use of breath fresheners to e.g., enhance an individual's oral freshness, such as, e.g., oral cleanliness, oral odor and/or the like, has become widely accepted. A wide variety of breath fresheners exist in the market, such as, e.g., various breath freshening confectioneries and candies and/or the like, such as, e.g., mint-flavored fresheners, cinnamon-flavored breath fresheners, fruit-flavored (such as, e.g., lemon, lime, orange, and/or the like) breath fresheners; and/or the like. Some existing breath fresheners include that of, e.g., ALTOIDS®, TIC TAC®, CERTS® and various other breath freshener products.

Oral Hygiene

In modern culture, the use of items to enhance an individual's oral hygiene while away from home is not as widely accepted. In some instances, individuals may carry dental floss containers or tooth picks with which they may attend to their oral hygiene and/or oral freshening.

However, while individuals often freely take breath fresheners away from home and/or in the accompaniment of others, individuals are often more reluctant to bring and/or use dental floss and/or tooth picks away from home and/or in the accompaniment of others. Among other things, the use and carrying of dental floss alone can often have a negative connotation, such as, e.g., creating the appearance of vanity or a compulsion. As a result, in order to utilize oral freshening products, an individual often must wait until they are at home. While individuals may own and use dental floss or the like, in many contexts, individuals will not carry such products with them away from home. By way of example, after finishing a meal, an individual may wish to remove food remnants from between his or her teeth but he or she may be unwilling to carry a roll of dental floss with him or herself. Among other things, the individual may not want to carry an additional hygienic item with them and/or he or she may have left the oral hygiene product in their personal lavatory.

There has been a need for a product that can overcome some of the above and/or other problems.

### SUMMARY

The preferred embodiments of the present invention have been developed in view of the above mentioned and/or other issues in the related art. In some embodiments, one or more of the above and/or other problems related to oral hygiene can be overcome. In addition, some preferred embodiments can advantageously provide a highly unique breath freshening container product having unique functional qualities.

According to some illustrative embodiments, an oral-product container is provided that includes: a) a plurality of breath fresheners contained therein for breath freshening purposes; b) an elongated dental instrument for hygiene improving purposes contained within a compartment in said container; c) said container having a dispensing opening for dispensing breath fresheners; d) said container having a laterally movable cover mounted to move between a closed state in which said cover covers both said dispensing opening and said elongated dental instrument and an open state in which said cover exposes both said dispensing opening and said elongated dental instrument. In some embodiments, said dental instrument is configured to extend between a user's teeth for cleaning debris from between one's teeth. In some examples, said elongated dental instrument is a toothpick. In some examples, said elongated dental instrument is a piece of floss. In some implementations, said piece of dental floss is fixed on a roll within an interior of said container.

According to some illustrative embodiments, a method of freshening an individual includes: a) providing the individual with a container having a plurality of breath fresheners contained therein and an elongated dental instrument that is fixed within the container underneath the same cover that exposes a dispensing opening for said breath fresheners; b) having the individual place at least one of said breath fresheners in the individual's mouth for breath freshening purposes; and c) having the individual use the dental instrument for dental hygiene improving purposes.

According to some illustrative embodiments, an oral-product container includes: a) a plurality of breath fresheners contained therein for breath freshening purposes; and b) a roll of dental floss for oral hygiene improving purposes. In some embodiments, the dental floss can be accessed from the exterior of said container when said container is closed. In some illustrative embodiments, said breath fresheners include at least one flavor from the group consisting of: peppermint; spearmint; other mint flavors; wintergreen, cinnamon, licorice; citric flavors; sour flavors; and herbal or spice flavors.

According to some illustrative embodiments, a method of distributing the containers can include, e.g.: filling a plurality of said containers in a packaging container; and transporting the filled packaging container to a retail center (such as, e.g., for direct sales to consumers).

According to some illustrative embodiments, a method of freshening an individual includes: providing the individual with a container having a plurality of breath fresheners contained therein and a spool of dental floss; having the individual utilize a portion of the dental floss contained therein for oral hygiene improving purposes; and having the individual place at least one of said breath fresheners in the individual's mouth for breath freshening purposes. In some embodiments, said oral hygiene improving purposes can include removing excess and/or unwanted food particulates from between an individual's teeth.

The above and/or other aspects, features and/or advantages of various embodiments will be further appreciated in view of the following description in conjunction with the accompanying figures. Various embodiments can include and/or exclude different aspects, features, and/or advantages where applicable. In addition, various embodiments can combine one or more aspect or feature of embodiments where applicable. The descriptions of aspects, features and/or advantages of particular embodiments should not be construed as limiting other embodiments or the claims.

### BRIEF DESCRIPTION OF THE DRAWINGS

The accompanying figures are provided by way of example, without limiting the broad scope of the invention of various other embodiments, wherein:

FIG. 1 is an exploded perspective view showing an illustrative container having a base, an insert and a laterally slidable cover;

FIG. 2 is a top view of a container body having a dispensing opening and a toothpick mounted in the top surface of the container body;

FIG. 3 is a perspective view showing an illustrative container having a laterally pivotable cover;

FIG. 4 is a schematic dual-side perspective view of the upper portion of the container, without lid, according to some illustrative embodiments;

FIG. 5 is a schematic side perspective view of a container, with lid, according to some illustrative embodiments;

FIG. 6 is a schematic side perspective view of a container, without lid, according to some illustrative embodiments; and

FIGS. 7 and 8 show some additional inventions in which aspects shown and described can be employed within one or more of the container designs of the present application or of any of the containers shown in the above-noted patent applications incorporated herein by reference.

### DETAILED DESCRIPTION OF THE PREFERRED EMBODIMENTS

The following description sets forth some illustrative preferred embodiments of the invention. It should be understood based on this disclosure that the following description is illustrative and non-limiting and that various modifications, alterations, changes and/or the like can be employed in various embodiments of the invention. In addition, various components of the various embodiments can be replaced with equivalent structures (including presently known equivalents and/or future known equivalents) as would be understood based on this disclosure.

According to some illustrative embodiments, an oral-product container is provided that includes: a) a plurality of breath fresheners contained therein for breath freshening purposes; b) an elongated dental instrument for hygiene improving purposes contained within a compartment in said container; c) said container having a dispensing opening for dispensing breath fresheners; d) said container having a laterally movable cover mounted to move between a closed state in which said cover covers both said dispensing opening and said elongated dental instrument and an open state in which said cover exposes both said dispensing opening and said elongated dental instrument. In some embodiments, said dental instrument is configured to extend between a user's teeth for cleaning debris from between one's teeth. In some examples, said elongated dental instrument is a toothpick. In some examples, said elongated dental instrument is a piece of floss.

### Illustrative Embodiments

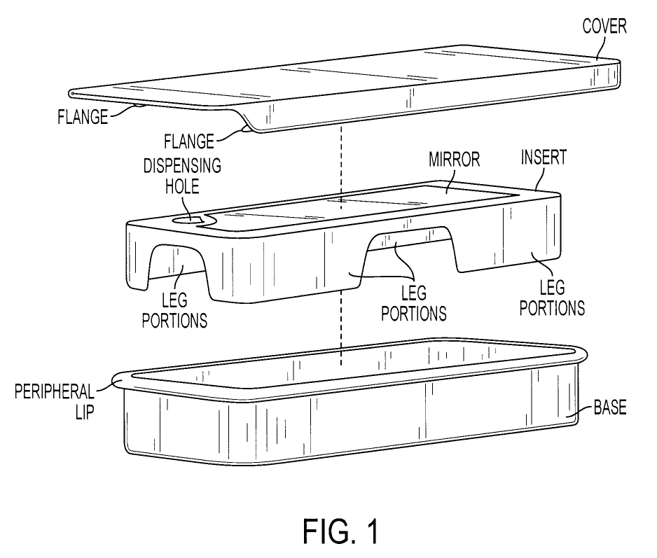

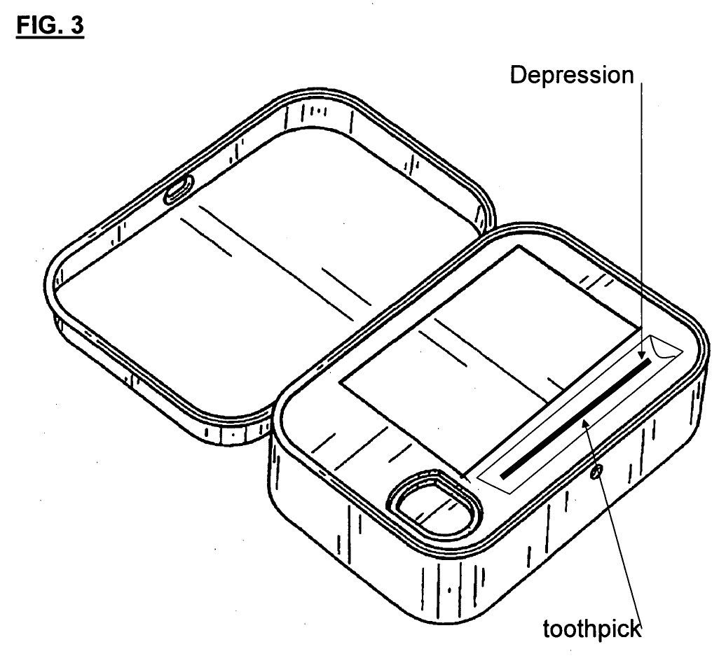

FIGS. 1 to 3 show some illustrative embodiments of the invention related to toothpick type dental instruments. In this regard, according to some preferred embodiments, a toothpick type dental instrument can be retained within a compartment that is accessed upon lateral movement of a cover, such as, e.g., a laterally slid cover as shown in FIG. 1 or a pivotal cover as shown in FIG. 3.

With reference to FIG. 1, as shown, in some embodiments a plurality of breath fresheners (e.g., small bite-sized mints, such as, e.g., any of the breath fresheners shown in the above-noted applications incorporated herein by reference) can be retained inside the container under the insert depicted. In that case, the insert would be inserted into the base so as to enclose the breath fresheners, with the exception of the ability to be dispensed through the dispensing opening, as described in the background references discussed above. The leg portions would preferably be press-fit within the base to retain the insert in the base. Then, the cover would preferably laterally slide over the base, with the flanges of the cover acting as channels that receive the peripheral lip of the base such that the cover can be laterally slid to expose the dispensing hole.

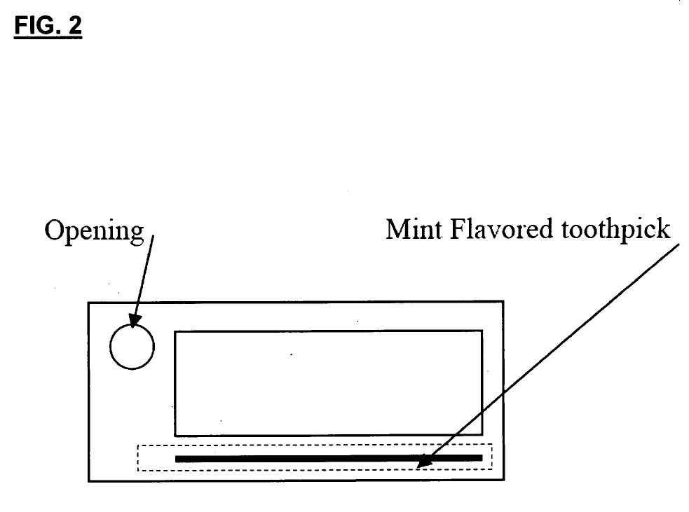

As shown in FIG. 2, in some embodiments, the container can be modified so as to include a compartment for retaining a toothpick dental instrument. In some embodiments, the insert can be modified to include a depression or cavity into which the toothpick can be retained. For example, the depression could be sized to hold the toothpick upon laterally sliding the cover to a closed position. Then, upon laterally sliding the cover to an open position, the toothpick can be either dispensed by turning the container over or by grasping the toothpick with one's fingers (e.g., grasped if the depression is wide enough to enable a user's fingers to grasp therein or if the depression is shallow enough to have the toothpick extend above a surface of the insert within grasp of a user's fingers.

With reference to FIG. 3, in another embodiment, one or more toothpicks (one shown in this illustrative example) can be retained within a depression in a similar insert as depicted. The embodiment shown in FIG. 3 is generally similar to that shown in FIG. 1 except that the cover is a pivoted cover, such that the cover is laterally moved to expose both a dispensing opening and the toothpick(s) by pivoting, rather than by sliding as shown in FIG. 1. It is contemplated that the container can include a variety of modifications and that a cover can be mounted in a variety of other manners according to some other embodiments, such as, e.g., to rotate, to snap off completely, etc.

In the preferred embodiments, referring to FIGS. 1-3, upon opening the cover, the elongated dental instrument is in plain view to the user, with the elongated dental instrument that is exposed extending along a top surface of the container beneath the cover.

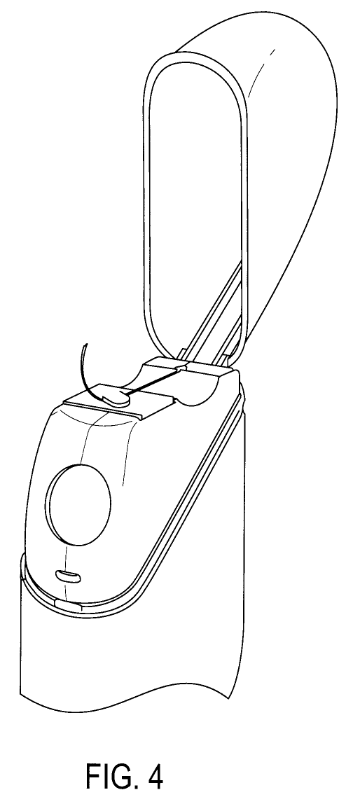

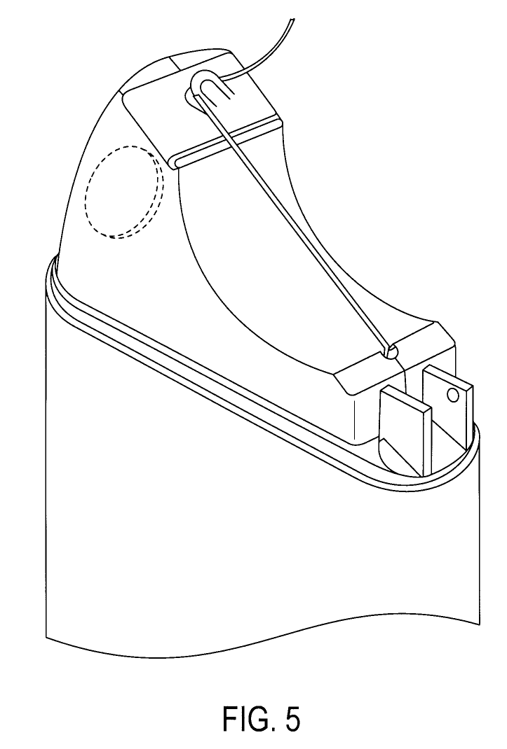

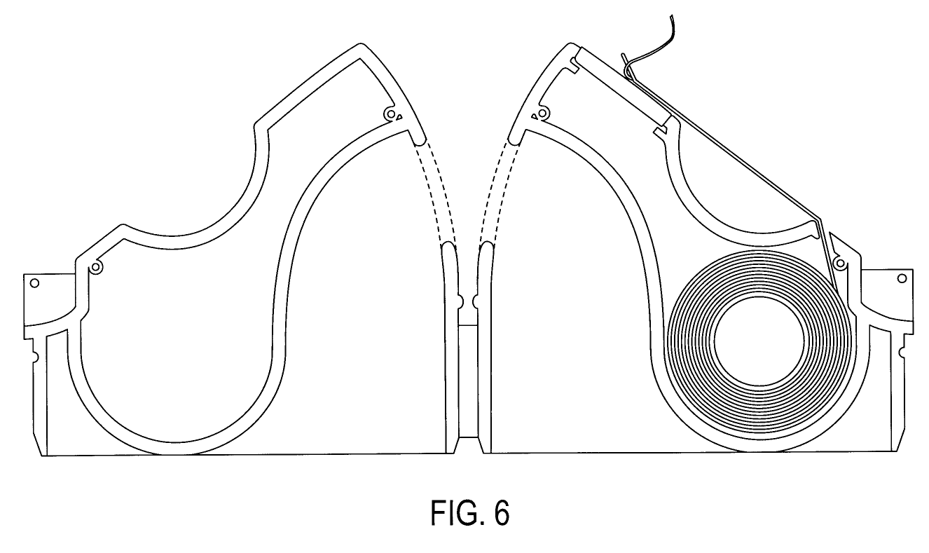

FIGS. 4-6 show an illustrative second embodiment of the invention. In some preferred embodiments (such as, e.g., in the illustrative implementations of the embodiment shown in FIGS. 4-6), an oral-product container is provided that includes: a) a plurality of breath fresheners contained therein for breath freshening purposes; and b) a roll of dental floss for oral hygiene improvement. Although one illustrative embodiment is shown, it should be understood based on this disclosure that the illustrative embodiments can vary widely and that this is merely a preferred example.

In preferred embodiments, the container can be used by an individual in order to orally consume one or more breath freshener for breath freshening purposes and/or utilize dental floss for oral hygiene improvement. In this disclosure, the terminology oral hygiene improvement includes the removal of excess food particulates from between teeth.

In some preferred embodiments, the container can be made with metal, such as, e.g., of tin, aluminum, stainless steel, iron, copper and/or other metal. In some preferred embodiments, the container can be made with natural and/or synthetic resins, such as, e.g., various plastics and/or the like. In some preferred embodiments, the container can be shrouded within a plastic wrap and/or another wrapping medium, such as, e.g., a foil wrap. Among other things, such a wrap can help protect the contents within the container and/or can help to protect the container itself. Such a plastic wrap could be, e.g., a manually removable that is removed by an end consumer who uses the container for oral freshening and/or oral hygiene improving purposes. In some embodiments, a plurality of containers can be wrapped together for bulk sales to a consumer (such as, e.g. in groups of 2, 4, 6, 12 and/or the like).

Oral Products

In some preferred embodiments as shown in FIGS. 4 to 6, a roll of dental floss will be employed for oral hygiene improving purposes.

In the preferred embodiments, a plethora of different oral-products can be contained within the containers. In some, embodiments, the oral-products can include, e.g., breath fresheners. For example, such breath fresheners may, e.g., enhance an individual's oral freshness, such as, e.g., oral odor and/or the like. Various embodiments can use any currently known and/or later known fresheners, such as, e.g., various breath freshening candies and/or the like, such as, e.g., mint-flavored fresheners, cinnamon-flavored fresheners, fruit-flavored (such as, e.g., lemon, lime, orange and/or the like) fresheners and/or the like. In some embodiments, breath fresheners similar to ALTOIDS®, TIC TACS®, BARKLEYS®, CERTS® and/or various other breath freshener products can be used.

In some illustrative embodiments, oral products can include one or more of the following:

a) gum (such as, e.g., wrapped chewing gum strips [such as, e.g., WRIGLEY'S BIG RED® gum sticks, WRIGLEY'S SPEARMINT® gum sticks, etc.], gum balls [such as, e.g., EVERCREST® mint gum balls, etc.];

b) candy coated gum (such as, e.g., WRIGLEY'S ECLIPSE® rectangular gum chews);

c) hard-confectionary (such as, e.g., hard mints);

d) quick-dissolving confectionary (such as, e.g., quick dissolving mints)(such as, e.g., lasting under about 30 seconds in normal usage in an adult user's mouth);

e) slow-dissolving confectionary (such as, e.g., longer lasting mints or lozenges) (such as, e.g., lasting over one minute in normal usage in an adult user's mouth);

f) strip-shaped confectionary (such as, e.g., ALTOIDS® strips and/or LISTERINE POCKET PACKS®, etc.); and/or

g) liquid-filled confectionary (such as, e.g., a hard-shelled mint with a liquid center).

As with the embodiments shown in FIGS. 1-3, in the preferred embodiments of the type shown in FIGS. 4 to 6, the cover is positioned so as to concurrently close or expose both the dental instrument and the dispensing opening. In addition, in the preferred examples of the embodiments shown in FIGS. 4 to 6, as with the foregoing embodiments, upon opening the cover, the elongated dental instrument is in plain view to the user, with the elongated dental instrument that is exposed extending along a top surface of the container beneath the cover.

While a variety of illustrative oral products are described herein, it should be understood based on this disclosure that various embodiments can employ a variety of other oral products (such as, e.g., various food products [e.g., candies, confectionaries or other food products], medicinal products, flavored products and/or the like).

In some embodiments, the oral products can include breath fresheners having one or more of the following flavors: peppermint, spearmint, other mint flavors; wintergreen; cinnamon; licorice; citric flavors (e.g., lemon, orange, lime, etc.); sour flavors; herbal or spice flavors (e.g., garlic, onion and/or the like) and/or other now or later known breath freshener flavors.

In some embodiments, the oral products include all or substantially all natural ingredients. In some embodiments, all or substantially all of the ingredients contributing to the flavor of the oral products are natural ingredients.

In some embodiments, the oral products can include at least some or all of the following ingredients (such as, e.g., found in BARKLEYS PEPPERMINT® mints): sugar; powdered glucose; sorbitol; maltodextrin; magnesium stearate; oil of peppermint (e.g., triple distilled oil of peppermint); natural and artificial flavors. In some embodiments, the oral products can include at least some or all of the following ingredients (such as, e.g., found in BARKLEYS WINTERGREEN® mints): sugar; powdered glucose; maltodextrin; magnesium stearate; artificial flavors. In some embodiments, the oral products can include at least some or all of the following ingredients (such as, e.g., found in BARKLEYS CINNAMON® mints): sugar; powdered glucose; maltodextrin; magnesium stearate; natural and artificial flavors; oil of cinnamon.

In some embodiments, the oral products have very low calories. In some embodiments, the oral products have very low carbohydrate values, such as, e.g., less than about 10 grams per serving, or, more preferably, less than about 5 grams per serving, or, more preferably, less than about 2 grams per serving.

In some embodiments, the breath fresheners can be made to temporarily mask bad breath and/or a bad taste in one's mouth. In some embodiments, the breath fresheners can be made to (e.g. using chemicals, compounds or the like) help reduce bacteria (e.g., anaerobic bacteria) in a user's mouth.

In some embodiments, the breath fresheners can include xylitol. Among other things, xylitol can be used as a natural sweetener that may help avoid and/or fight cavities.

In the preferred embodiments, in the device shown in FIG. 2, a base (which is preferably made of plastic, or a formed metal, such as, e.g., tin or aluminum) is provided that contains (e.g. snugly receives) a top insert, as shown in FIG. 1, that holds a roll of dental floss as shown.

In the preferred embodiments, as shown in FIGS. 1 and 2, during assembly the insert can be easily removed. Then, product (e.g. mints or gum) can be easily loaded into the base. Then, the insert can be easily placed over the product so as to contain the product within the base.

Additional Inventions

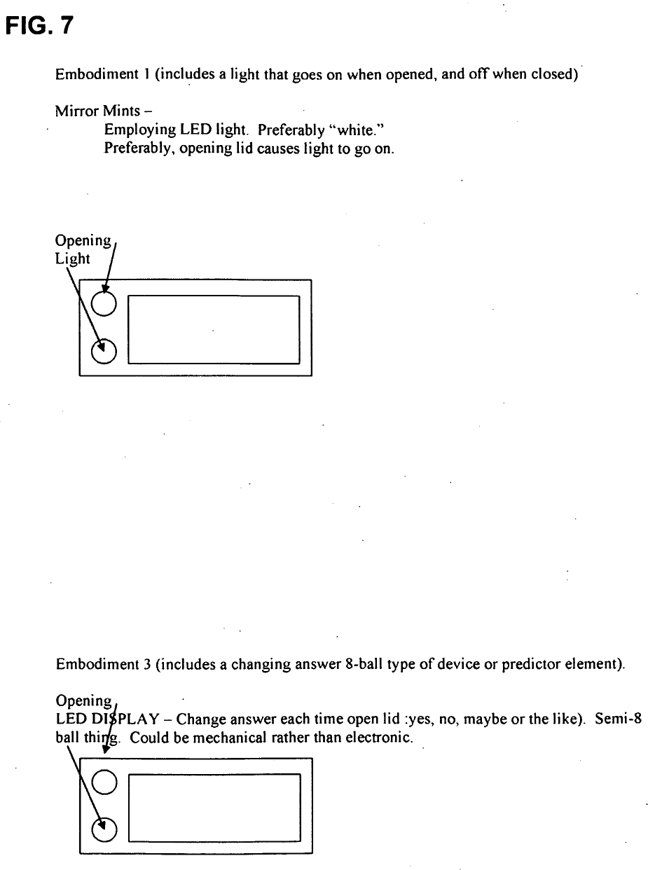

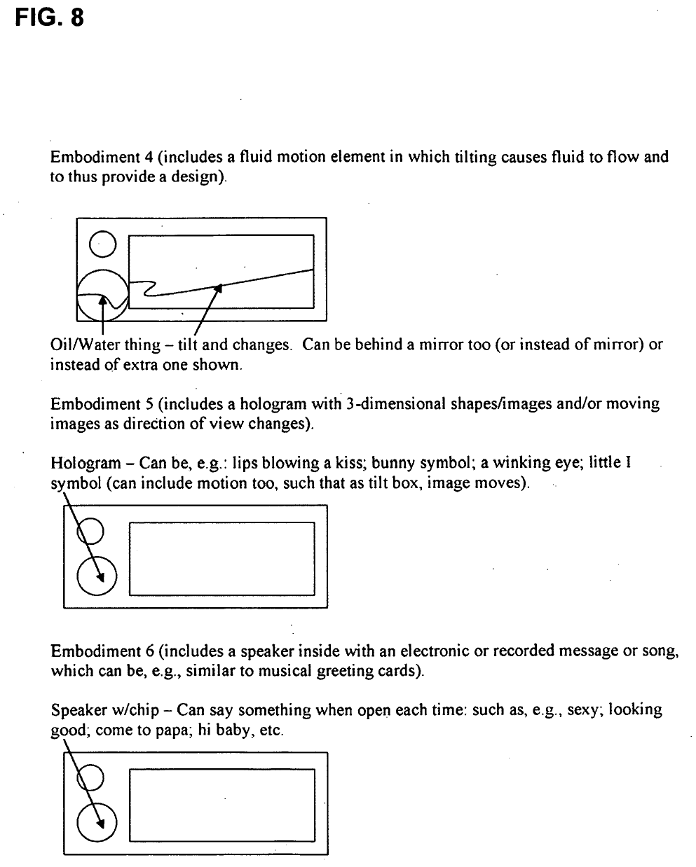

FIGS. 7 and 8 show some additional inventions in which aspects shown and described can be employed within one or more of the container designs of the present application or of any of the containers shown in the above-noted patent applications incorporated herein by reference. These inventions may be claimed in one or more divisional patent applications.

### BROAD SCOPE OF THE INVENTION

While illustrative embodiments of the invention have been described herein, the present invention is not limited to the various preferred embodiments described herein, but includes any and all embodiments having modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which are to be construed as non-exclusive. For example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited.

What is claimed is:

1. An oral-product container, comprising:
a) a plurality of breath fresheners contained therein for breath freshening purposes;
b) an elongated dental instrument for hygiene improving purposes contained within said container;
c) said container having a dispensing opening for dispensing breath fresheners;
d) said container having a laterally movable cover mounted to move between a closed state in which said cover covers both said dispensing opening and said elongated dental instrument and an open state in which said cover exposes both said dispensing opening and said elongated dental instrument.

2. The oral-product container of claim 1, wherein the elongated dental instrument is mounted such that in an open state it extends along a top surface of the container beneath the cover.

3. The oral-product container of claim 1, wherein said dental instrument is configured to extend between a user's teeth for cleaning debris from between one's teeth.

4. The oral-product container of claim 2, wherein said elongated dental instrument is a toothpick.

5. The oral-product container of claim 2, wherein said elongated dental instrument is a piece of floss.

6. The oral-product container if claim 5, wherein said piece of dental floss is fixed on a roll within an interior of said container.

7. The oral-product container of claim 1, wherein said breath fresheners include at least one flavor from the group consisting of:
peppermint; spearmint; other mint flavors; wintergreen; cinnamon; licorice; citric flavors; sour flavors; and herbal or spice flavors.

8. The oral-product container of claim 1, wherein said dental instrument includes at least one flavor from the group consisting of:
peppermint; spearmint; wintergreen; cinnamon; and flavorless.

9. The oral-product container of claim 6, wherein said roll is mounted so as to rotate around an axis that is substantially perpendicular to a front face of said container.

10. The oral-product container of claim 6, wherein said roll is mounted so as to rotate around an axis that is substantially horizontal when said container is oriented in an upright condition.

11. The oral-product container of claim 1, wherein said container is between about 2 and 4 inches tall in a lengthwise direction.

12. The oral-product container of claim 1, wherein said container has a narrowest width of between about ¼ inch and ¾ inch.

13. A method of freshening an individual, comprising: a) providing the individual with a container having a plurality of breath fresheners contained therein and an elongated dental instrument that is fixed within the container underneath the same cover that exposes a dispensing opening for said breath fresheners; b) having the individual place at least one of said breath fresheners in the individual's mouth for breath freshening purposes; and c) having the individual use the dental instrument for dental hygiene improving purposes.

14. An oral-product container, comprising:
a) a plurality of breath fresheners contained therein for breath freshening purposes; and
b) a roll of dental floss for hygiene improving purposes, wherein said roll of dental floss is fixedly mounted to said container.

15. The container of claim 14, further including a lid such that the dental floss and mints can be protected from external environmental factors under the cover; and wherein said roll of dental floss is isolated from the container interior such as to be separate from the oral breath freshening protect therein.

16. The container in claim 15, wherein said roll of dental floss is on an interior of said container when said container is closed.

17. The container of claim 15, wherein said roll is mounted so as to rotate around an axis that is substantially perpendicular to a front face of said container.

18. The container of claim 15, wherein said roll is mounted so as to rotate around an axis that is substantially horizontal when said container is oriented in an upright condition.

19. The container of claim 15, wherein said container is between about 2 and 4 inches tall in a vertical direction.

20. The container of claim 15, wherein said container has a front to back width of between about ¼ inch and ¾ inch in a horizontal direction.
